(19) United States
(12) Patent Application Publication
(10) Pub. No.: US 2010/0108291 A1
(43) Pub. Date: May 6, 2010

(54) Method and apparatus for embedded battery cells and thermal management

(75) Inventors: Per Onnerud, Framingham, MA (US); Phillip E. Partin, Grafton, MA (US); Scott Milne, Boston, MA (US); Yanning Song, Chelmsford, MA (US); Richard V. Chamberlain, II, Fairfax Station, VA (US); Nick Cataldo, Greenwich, CT (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Boston-Power, Inc., Westborough, MA (US)

(21) Appl. No.: 12/584,765

(22) Filed: Sep. 11, 2009

Related U.S. Application Data
(60) Provisional application No. 61/191,846, filed on Sep. 12, 2008.
(60) Provisional application No. 61/194,382, filed on Sep. 26, 2008.

(51) Int. Cl. F28F 7/00; H01M 10/50

(52) U.S. Cl. 165/80.2; 429/120

(57) ABSTRACT

Battery cells are embedded in a device to control thermal management of the device. One embodiment includes an embedded battery arrangement that improves thermal management of a portable computer, such as heat transfer and dissipation from heat generating components of the portable computer (including, for example, central processing unit chips or graphics processing unit chips). In one specific embodiment, a printed circuit board is mounted to a battery pack to cause improved radiation of heat from heat generating components of the portable computer to outside of the portable computer housing. In another embodiment, battery cells are distributed within the housing of a portable computer that improves thermal management.

### RELATED APPLICATIONS

This application claims the benefit of U.S. Provisional Application No. 61/191,846, filed on Sep. 12, 2008, and U.S. Provisional Application No. 61/194,382, filed on Sep. 26, 2008 for Embedded Battery Cells and Thermal Management of Personal Computers by Per Onnerud, Phillip E. Partin, Scott Milne, Yanning Song, Richard V. Chamberlain, II, and Nick Cataldo, the teachings of both of which are incorporated herein by reference in their entirety.

### BACKGROUND OF THE INVENTION

Portable computers (or notebooks) typically include a single main battery that is charged and stores energy from an external alternating current to a direct current (AC/DC) adapter. Currently the main battery is a lithium ion battery and adds approximately one pound to the overall weight of the portable computer. The main battery degrades and may need to be replaced in one to five years. Degradation of the main battery may be due to use or due to failures in the cooling systems of the portable computer. Failures in the cooling system (e.g., a fan or heatsink) may be caused by collection of dust and debris, which will cause the entire portable computer to get hotter and hotter to the touch and for the cooling system to become louder over time.

### SUMMARY OF THE INVENTION

The summary that follows describes some of the example embodiments included in this disclosure. The information is proffered to provide a fundamental level of comprehension of aspects of this disclosure.

An example embodiment of the present invention includes a portable computer and corresponding method. The portable computer may include at least one heat generating component and a battery cell thermally coupled to the at least one heat generating component. The heat generating component may be a processor, e.g., a central processing unit (CPU) chip or a graphics processing unit (GPU) chip, which may be thermally bonded to the battery cell. The battery cell may be a prismatic aluminum cell or a positive electrode. The battery cell may be oriented under the palm rest of the portable computer. The battery cell may have a heat capacity that is greater (e.g., at least an order of magnitude greater) than the heat capacity of the heat generating component. A thermal attachment block or heat pipe may be thermally coupled between the at least one heat generating component and the battery cell.

Another example embodiment of the present invention includes at least one radiating wall of the battery cell having an enhanced surface area with extruded heat sink/features (e.g., fins, pins, or the like). Additionally, the battery cell may be coupled to a cooling assembly, which may include a fan to direct airflow across the radiating wall of the battery cell. The battery cell may also be enclosed in a shield to protect the battery cell from direct heat radiation.

An example embodiment of the present invention may also include a motherboard of the portable computer and the battery cell may be coupled to the motherboard, for example, using a clip to allow for detachment.

A battery cell may be embedded within the motherboard of the computer in another example embodiment of the present invention. The battery cell may also be located on top of, within, or spanning the motherboard of the portable computer.

Another example embodiment of the present invention may include a plurality of cells within a battery cell pack housing and coupled to the at least one heat generating component. The cell pack housing may be located under the palm rest of the portable computer.

An example embodiment of the present invention may include charge management control that preferentially charges the battery cell during times when cooling is required.

Another example embodiment of the present invention may include additional portable computer components (e.g., hard disk, optical drive, etc.) that are enclosed in a shield and the shield is configured to protect the hard disk from direct heat radiation.

An example embodiment of the present invention may also include a plurality of cells distributed within a portable computer housing and each of the plurality of cells are individually, thermally coupled to the at least one heat generating component. The plurality of cells may be individually enclosed in a shield to protect from direct heat radiation. The plurality may also be coupled to a motherboard of the portable computer, for example using at least one clip to allow for detachment. The plurality may be comprised of prismatic aluminum cells and located under the palm rest of the portable computer.

Current notebook personal computers (or notebook PC) typically include an external battery that is enclosed in a plastic case and designs attempt to minimize heat transfer from the notebook to the battery pack because heat is known to degrade battery cells in their present form. Embodiments of the present invention may allow for battery cells to be embedded into the notebook PC design and for the embedded battery cells to act as a heat sinks if a means exists for transporting the heat out of the notebook PC. The battery cells may be adjacent to surfaces made out of material having high thermal conductivity, e.g., metal, engineered thermal materials, or the like. Using the embedded battery cells may minimize the amount and size of dedicated heat sinks, heat pipes, fans and other means of thermal management inside the notebook PC. The reduction of the need for both passive and active thermal management inside the notebook PC saves cost, space, and allows the manufacturer of the notebook PC to have more freedom in the overall designing process.

### BRIEF DESCRIPTION

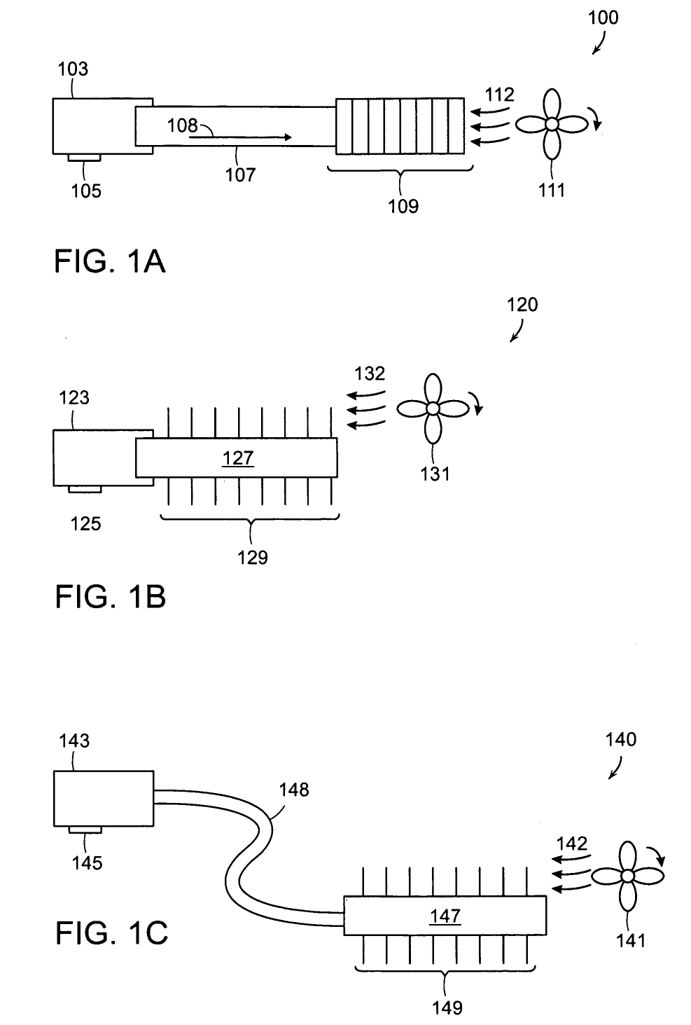

FIGS. 1A-1C illustrate several configurations for thermal management using a notebook heat transfer and dissipation device of a portable computer that may be employed in accordance with an embodiment of the present invention;

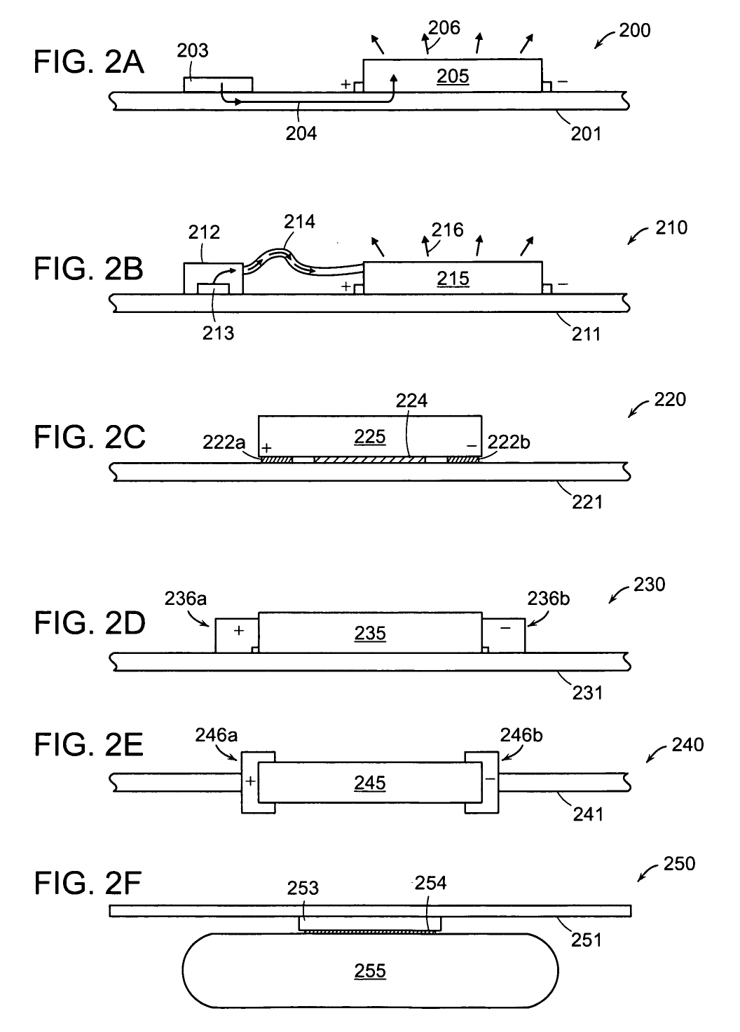

FIGS. 2A-2F illustrate several configurations of a circuit board mounted notebook battery that may be employed in accordance with an embodiment of the present invention;

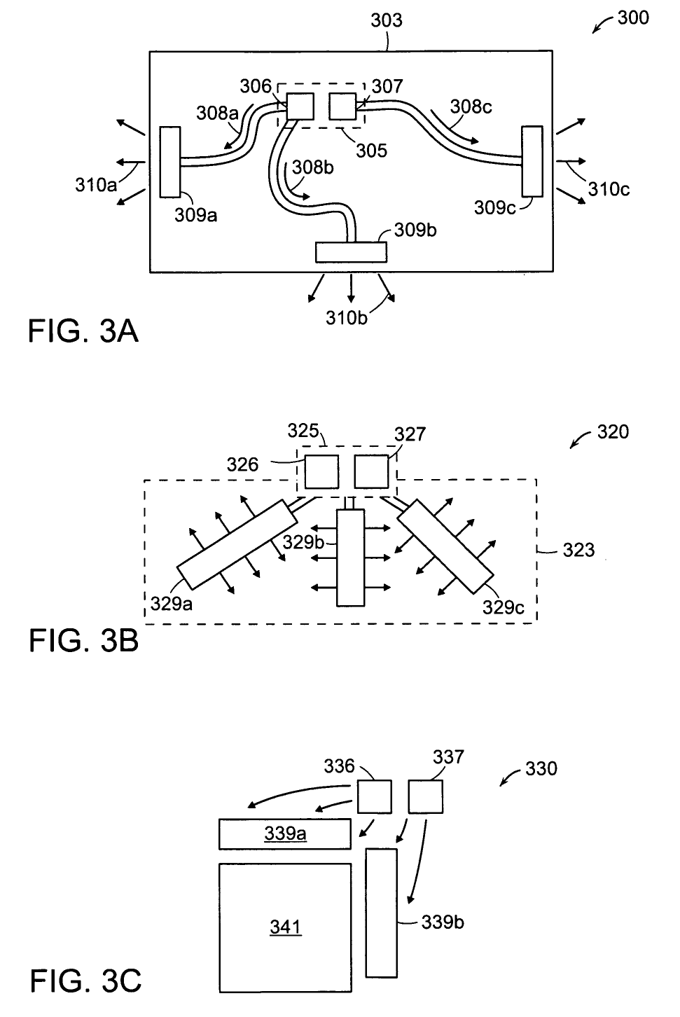

FIGS. 3A-3C illustrate several configurations of a distributing battery cells within a portable computer in accordance with an example embodiment of the present invention;

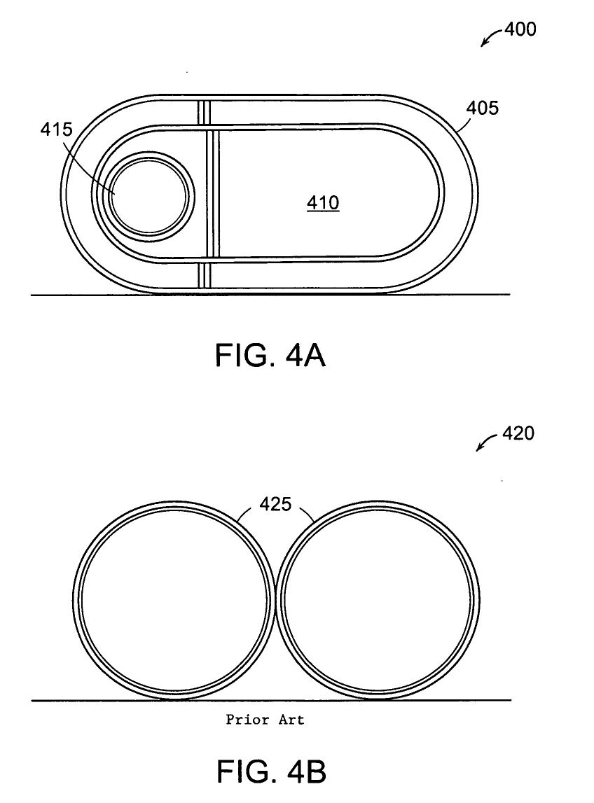

FIGS. 4A and 4B illustrate a comparison of contact surface area of an oblong cell battery and two 18650 cells;

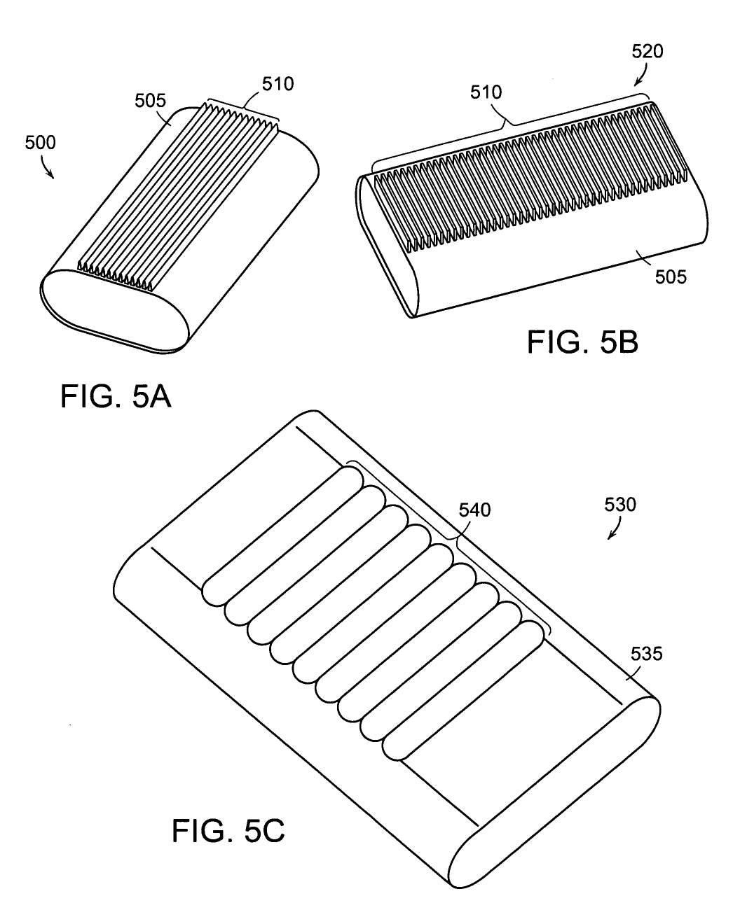

FIGS. 5A-5C illustrate battery cell can designs that may be modified for improved heat transfer in accordance with an example embodiment of the present invention;

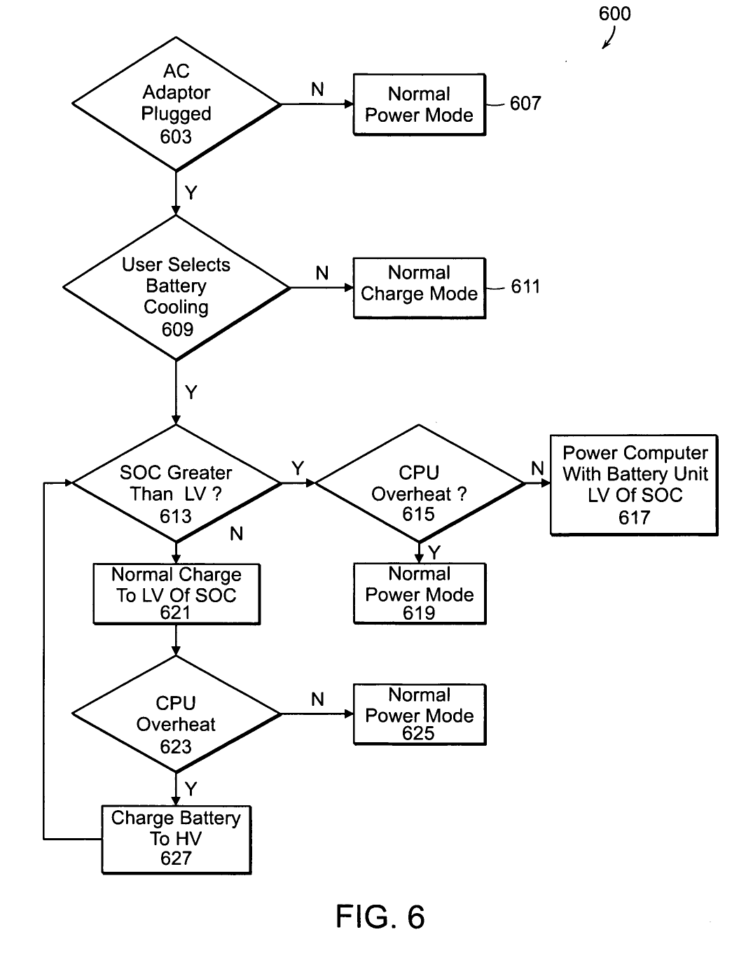

FIG. 6 depicts an algorithm that may be employed for cooling a central processing unit within the personal computer in accordance with an example embodiment of the present invention; and

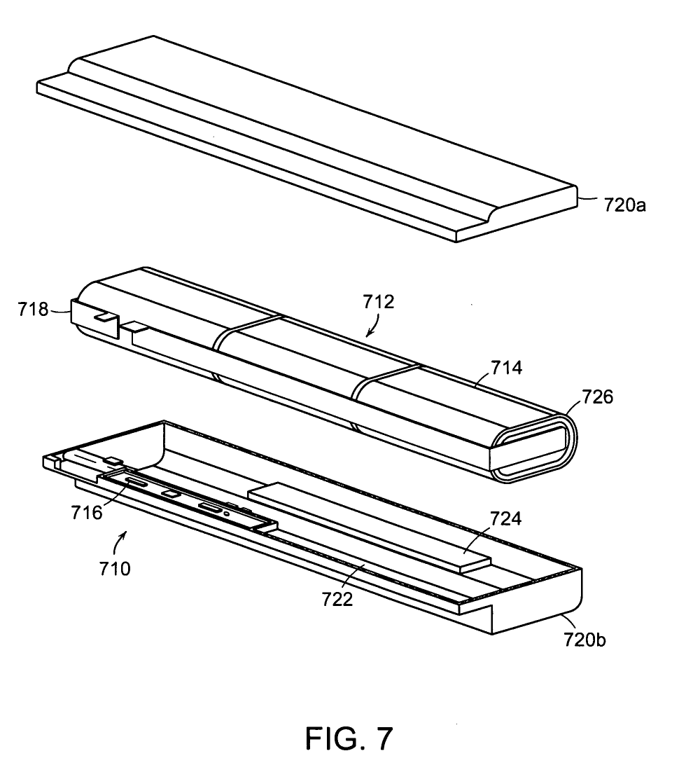

FIGS. 7-9 illustrate exploded views of battery packs that may be employed in accordance with an example embodiment of the present invention.

### DETAILED DESCRIPTION OF THE INVENTION

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

The present application is directed to a device comprising: at least one heat generating component and a battery cell thermally coupled to the at least one heat generating component. The device may be portable. The battery cell may be rechargeable, which includes lithium in a cathode of the battery.

Several configurations of the present invention for thermal management of a device using a battery are illustrated in FIGS. 1A-1C. Each configuration involves using a battery as a thermal heat transfer channel (e.g., heat transfer 108 of FIG. 1A) from CPU/GPU chip to extruded features (e.g., radiating fins or extruded heat sink 109 of FIG. 1A).

FIG. 1A illustrates battery 107 attached to a CPU/GPU chip 105, which is the heat generating component, via a thermal attachment block 103. At another location, battery 107 is attached to the radiating fins or extruded heat sink 109. Heat is transferred 108 from CPU/GPU chip 105, through battery 107 to radiating fins 109. Fan 111 may be additionally be employed to increase air flow 112 across the radiating fins 109. A benefit of using a battery 107 for thermal transfer is reduction or elimination of need for other heat transfer channels (such as a heat pipe 148 of FIG. 1C or other thermally conducting structures) in the portable computer. As a result, the cost of materials and manufacturing complexity can be significantly reduced. The overall size of the thermal management solution is reduced, so the size of the notebook may be reduced.

Another configuration shown in FIG. 1B includes the addition of radiating fins or extruded features 129 at the surface of a battery 127, which may increase the surface area of the battery 127 and provide increased dissipative heat transfer from the battery 127 into the surrounding air. Here, the battery 127 is serving a thermal dissipative function. Air fan 131 may be configured to blow air 132 across the battery 127 in a way to increase the heat dissipation effect. A thermal attachment block 123 may be used to attach battery 127 to CPU/CPU chip 125. In FIG. 1B, for example, battery 127 is in close proximity to the CPU/GPU chip 125, which improves compactness of the overall portable computer design.

FIG. 1C shows the addition of heat pipe 148 to allow placement of a battery 147 in a variety of locations in the device's enclosure which may include, for example, extending the battery 147 to the edge of the portable device's enclosure where the battery 147 will dissipate excess heat to the atmosphere. Battery 147 may be employed in a heat-dissipative configuration because the battery 147 has radiating fins or extruded features 149 on a surface of the battery 147. The battery 147 may have additional heat-dissipative features because it has a significantly greater volumetric heat capacity as compared to the heat of the CPU/GPU chip 145, and because CPU/GPU chip 145 operates at a lower temperature than battery 147. Further, battery 147 can dissipate heat more rapidly than CPU/GPU chip 145 by virtue of the materials of construction of battery 147, such as the container component of battery, within which the electrodes and electrolyte of battery 147 reside.

The present application is also directed to a portable computer comprising at least one heat generating component and a battery cell thermally coupled to the at least one heat generating component. The heat generating component may be a processor (e.g., central processing unit chip or graphics processing unit chip), which may be thermally bonded to the battery cell. As used herein, “thermally bonded” means a pathway for thermal conduction, such as between a heat source and a battery that is better than what would occur in the absence of the pathway, while continuing to maintain electrical insulation between these same components. Examples include the use of thermally conductive epoxy, adhesive or electrical insulator film materials. Common terms for some such materials include “gap filler” and “gap pads” that describe the role of such materials to allow for efficient heat conduction between two components, such as a heat source and battery, without creating an electrically conducting path. This would allow taking advantage of the heat sink properties of the battery as described in this invention. Some examples of acceptable materials for thermal bonding include, but is not limited to, multiple Bergquist products, for example, Sil-Pad, Gad Pad, and Gap Filler brand name products, as well as multiple Emerson & Cuming products, such as, Stycast brand name epoxy. The battery cell may be a prismatic aluminum cell. The heat capacity of the battery cell is greater than the heat capacity of the heat generating component, such that the heat capacity of the battery cell is at least an order of magnitude greater than the heat capacity of the heat generating component. The portable computer may also include charge management control that preferentially charges the battery cell during times when cooling of the at least one heat generating component is required.

The battery cell may have at least one radiating wall, which includes an enhanced surface area. The radiating wall may include fins, pins, extruded features or the like. The battery cell may be coupled to a cooling assembly, which includes a fan to direct airflow across the radiating wall of the battery cell.

FIGS. 2A through 2F illustrate example configurations of a portable computer comprising at least one heat generating component and a battery cell thermally coupled to the at least one heat generating component in accordance with an embodiment of the present invention.

As shown in FIG. 2A, battery 205 can be embedded in a portable computer by mounting on or within the printed circuit board (or circuit board) 201. Battery 205 may be electrically connected to conductive layers in the printed circuit board 205 to provide access to its stored electrical energy. Battery 205 is thermally connected to CPU/GPU 203 on the printed circuit board 201 to enable dissipation of excess heat using conductive layers in the printed circuit board 201.

Alternatively, FIG. 2B illustrates heat piping techniques commonly employed in the industry to allow remote placement of a battery 215 with respect to CPU/GPU 213, for example, to transfer heat from inside the portable computer to an edge where battery 215 is positioned to radiate heat to the atmosphere. An embedded lithium ion battery may be used for thermal management in a portable computer. In addition to its electrical energy storage function, the embedded battery may transfer and dissipate excess heat generated by chip devices on the portable computer's circuit board, such as the CPU and GPU. The use of portable computer batteries to provide thermal management in the portable computer offers many benefits to the manufacturer and end user. For example, thermal management component count is reduced or eliminated, which results in material and manufacturing cost savings. Fewer components in the notebook reduce its physical size and weight. Design flexibility is increased as batteries may be placed in closer proximity to heat generating components.

A portable computer may also include the motherboard of the portable computer and the battery cell may be coupled (e.g., using at least one clip) to the motherboard of the portable computer. FIG. 2C illustrates that a battery 225 can be incorporated as a component of printed circuit board 221. Removing the need for traditional battery pack packaging will reduce materials cost, space and weight requirements for the portable. The elimination of traditional thermal management components further reduces cost, size and complexity of the portable computer. A soldering connection technique between battery 205 and the circuit board 221 is designed to provide two paths, one path 222a to transfer stored electrical energy from the battery 225 to the circuit board 221 and a second path 222b to transfer thermal energy from thermal conduction layers in circuit board 221 to battery 225. In the case of a permanently mounted battery, shown in FIG. 2C, thermal connection 224 is formed to a large pad on the surface of circuit board 221 which is in turn connected to thermal conduction layers in the board. The thermal connection 224 material thermally bonds the battery 225 to circuit board 221 may include one of the following: electrical solder, thermally conductive paste, or a thermally conductive engineered material.

The ability of designers to place batteries on the printed circuit board provides additional design flexibility. For example, the battery cell may be detached from the motherboard; the battery cell may be embedded within or located on top of or spanning the motherboard of the portable computer; or the battery cell may be oriented under the palm rest of the portable computer. Employment of configurations, or features, that permit removal of battery 235 from printed circuit board 231, such as a compression clip 236, as shown in FIG. 2D, for example, enables service replacement of battery 105 during the lifetime of the notebook. The orientation of battery 235 with respect to circuit board 231 can be in a surface mounted orientation where battery 235 or battery mounting clips 246 are directly soldered to the surface of circuit board 231. This orientation, shown in FIG. 2D (using compression clips 236) and FIG. 2E (using mounting clips 246) will be well-suited for surface mount circuit board manufacturing techniques, such as automated component placement and solder reflow used currently in the industry. Battery 245 or battery mounting clips 246 may, alternatively, be mounted in a region where circuit board 241 material has been removed, such that circuit board 241 surrounds some or all of the mounted battery 245, such as is shown in FIG. 2E. This orientation enables a more compact fitting of the battery with the circuit board by reducing the height of the battery to either side of the board by approximately half of the surface mounted orientation.

In another approach, the battery may be thermally coupled 254 directly to the surface of a printed circuit board 251, as shown in FIG. 2F. Thermal coupling as illustrated in FIGS. 2C and 2F may be done by welding a thermally conductive pad to couple a battery cell(s) to the PCB 221 (of FIG. 2C) or the CPU/GPU 253 (of FIG. 2F), which provides an additional benefit of allowing for mechanical vibration damping to suppress vibration of components within the housing of a personal computer. One or more lithium ion battery cells may be distributed in a desirable configuration within a portable computer so as to provide thermal management of excess heat generated by heat generating components, such as a CPU or GPU, in accordance with an example embodiment of the present invention. A benefit of distributing batteries throughout the portable computer in thermally advantageous locations may be to increase the portable computer design flexibility. Designers may have new options to place heat sensitive components that may also allow for added cost, size and weight saving.

Distributed notebook battery cells may be mounted to the circuit board using techniques described in the descriptions of FIGS. 2A-2F. Using these mounting configurations, series and parallel electrical connections between the distributed cells may be established using conducting layers in the circuit board. Alternatively, cells may be mounted as part of the portable computer enclosure and connected in series or in parallel using discrete electrical bus wires or bars.

The portable computer may also include plurality of cells distributed within the housing of the portable computer. The plurality of cells may be individually, thermally coupled to the at least one heat generating component. The plurality of cells may also be individually enclosed in a shield, which protects the plurality of cells from direct heat radiation. In addition, the plurality of cells may be coupled (e.g., using at least one clip) to a motherboard of the portable computer. The plurality of cells may also be detached from the motherboard. The plurality of cells may be comprised of prismatic aluminum cells. The plurality of cells may also be located under the palm rest of the portable computer. The portable computer may also include a thermal attachment block that is thermally coupled between the at least one heat generating component and the battery cell. The portable computer may also include a heat pipe thermally coupled between the at least one heat generating component and the battery cell.

FIGS. 3A-3C illustrate several configurations of a distributing battery cells within a portable computer in accordance with an example embodiment of the present invention.

FIG. 3A illustrates the placement of battery cells 309a-c in selected locations to provide several thermal management roles, including dissipation of excess heat from inner locations to the edge of the notebook enclosure (or portable computer housing) 303. In this placement, heat pipes 308a-c may be used to move heat to the remotely located radiating batteries 309a-c, respectively. Finned batteries, such as are shown in FIGS. 1A-1C, in combination with fans, provide increased air flow. A heat attachment block 305 at the CPU 306 or GPU 307 may be employed to thermally interface the CPU 306/GPU 307 with the heat pipe. For example, depending on the amount of heat emitted from a heat generating component, additional heat pipes can be connected to assist with heat dissipation, such as CPU chip 306 connected to heat pipes 308a, 308b. Another placement, shown in FIG. 3B, provides diffusion of heat from a localized component, such as CPU chip 326 or GPU chip 327, to a larger surface area 323, such as the top surface or bottom surface of the portable computer enclosure where it may be radiated outward. Battery cells 329a-c may act as thermal transfer paths to direct heat from CPU chip 306 and GPU chip 307, by way of an attachment block 325, to a larger surface area 323. The attachment block 325 may enclose the CPU chip 326 and the GPU chip 327 to protect the chips from direct heat radiation. In addition, the larger surface area 323 can be, for example, a large stamped aluminum plate located underneath the keyboard, or at the bottom surface of the portable computer. Heat is then radiated from the larger surface area 323. As such, the portable computer may also include a hard disk, which is enclosed in a shield and the shield protects the hard disk from direct heat radiation. The portable computer may also include an optical drive, which is enclosed in a shield and the shield is configured to protect the hard disk from direct heat radiation.

Another placement, shown in FIG. 3C, provides thermal shielding between CPU 336 and GPU 337, and heat sensitive devices (or components) inside the portable computer, such as a hard disk drive, optical drive, solid state memory, keyboard or other user-input devices and user-contact areas. The shielding provides protection to the component, for example, to prevent data loss in a hard drive or solid state memory due to excess heat exposure. CPU 336 may have several connections to battery cell 339a, and GPU chip 337 may have several connections to another battery cell 339b (connections represented as arrows). Thermal shielding occurs because battery cells 339a, 339b are used to shield the temperature sensitive component 341 from the CPU chip 336 and the GPU chip 337.

FIGS. 4A and 4B illustrate a comparison of contact surface area of an oblong cell battery 400 and a battery 420 comprised of two cells. Typically, the container (or can) is of any suitable metal for fabricating a battery cell, such as stainless steel, aluminum, and nickel. Preferably, the material of the can is aluminum, which has relatively high thermal conductivity. Moreover, aluminum is relatively easy to configure into shapes that have high surface area, such as fins or corrugated surfaces.

As illustrated by FIG. 4A, a battery 400 may be employed that has a relatively large surface area per unit of volume. The battery 400 is comprised of a can 405 that encapsulates the battery cell 410. The top cap 415 provides a location upon which a positive tab may be connection (e.g., by welding) and a negative tab may be connected (e.g., by welding) onto a connection within the can 405 of the battery 400. FIG. 4b (prior art) illustrates a battery 420 that includes two 18650 battery cells 425. The use of the oblong cell battery 400 allows for the development of additional useable space (when compared to the 18650 battery cells 425). In addition, the oblong battery cell 400 allows for the use of the space contained within a battery pack (e.g., see battery pack 710 of FIG. 7) which allows for additional design capabilities.

As such, examples of suitable batteries for the present invention includes batteries having a high ratio of surface area to volume include batteries that have at least one relatively planar surface, such as prismatic battery cells, as illustrated by FIG. 4A. Particularly suitable batteries are those that are less susceptible to rapid temperature increase when overcharged, and which typically will operate at relatively low temperature. A specific example of a suitable battery cell is a lithium-ion type battery cell, such as an aluminum case, prismatic-shaped cell with approximate dimensions of 18×37×65 mm, a nominal operating voltage of 3.7 V and an internal AC impedance of approximately 25 mΩ, capable of delivery a capacity of 4400 mAh at current rates up to 8.8 A, while operating at temperatures ranging from −20 to 60 C, available from Boston-Power, of Westborough, Mass.

In the embedded design, the can of the battery cell employed can be specially designed to have a larger, or enhanced, surface area for heat transfer. Two examples are shown, in FIGS. 5A and 5B, of radiating pins extruding from at least one surface of the battery cell. Another embodiment is shown in FIG. 5C. In these designs, the surface of the can is not smooth but with many small cooling fins or corrugated surface. These fins or corrugations help to dissipate the heat.

The present application is also directed to a method for using a battery cell to assist in heat transfer within a portable computer comprising thermally coupling at least one heat generating component of the portable computer to the at least one heat generating component. The battery cell may then be coupled to a cooling assembly. The cooling assembly may be used to direct airflow across at least one radiating wall of the battery cell, wherein the at least one radiating wall of the battery cell has an enhanced surface area. The battery cell may be enclosed in a shield that protects the battery cell from direct heat radiation. The battery cell may be coupled to the motherboard of the portable computer, wherein coupling the battery cell includes using at least one clip. The battery cell may also be detached from the motherboard. The method may further include for charging the battery cells (preferentially) when cooling is required.

The method may further comprise including the battery cell in a plurality of battery cells distributed within a portable computer housing and individually, thermally coupled to the at least one heat generating component. In addition, the method may also include maintaining the temperature difference between each battery cell to within a difference of at least less than 10° C. or at least be less than 2° C. The method may also allow for maintaining the capacity difference between each cell to within a difference of at least less than 60 mAH.

The method may further comprise individually enclosing the plurality of battery cells in a shield configured to protect a respective battery cell from direct heat radiation. The method may also include coupling the plurality of battery cells to a motherboard of the portable computer or configuring the plurality of cells for detachment. The method may further comprise regulating processing speeds of the portable computer based on the temperature of the at least one heat generating component.

In the embedded design, the battery charging process, which is an endothermic (heat absorbing) process, may be coordinated with by using a method to control the thermal management of the computer. To do so, an algorithm can be employed to optimize the charging process to coordinate with a major heat source inside a portable computer, for example CPU or GPU chips. An example for the algorithm is shown in FIG. 6 for CPU cooling.

When the notebook computer is plugged in at 603 with an AC adaptor, the user may select 609 a charge profile either to charge the cells to a full charge (normal mode) 611, or allow a smart module to control the charge (charge cooling mode) at 613. Under the second alternative, when the electronics detect that the temperature of the CPU is over the pre-set limit (overheated) at 615, it will start the charging process at 619 to cool the CPU down by lowering the temperature of the battery (which operates at a lower temperature during charging). In addition, the module can also generate a buffer charging zone when the CPU temperature is low. In this case, the electronics switch to battery power until the state of charge (SOC) of the battery is below or equal to a pre-determined value (low voltage (LV) of SOC) even though the AC adaptor is plugged in, when it detects that the CPU temperature is low. In this way, the battery may be charged when it is needed to increase heat dissipation. The LV and high voltage (HV) may be set, for example, anywhere from 20% to 90% of SOC, preferably 40% to 80%.

If the AC adapter is not plugged in at 603, the portable computer is maintained in normal power mode 607. If the AC adapter is plugged in at 603, the user may select battery cooling at 609. If the user does not select battery cooling 609, the portable computer may be placed in normal charge mode 611. If the user selects battery cooling at 609, the algorithm may then approximate whether the SOC of the battery is greater than LV at 613, and the algorithm may approximate whether the CPU has overheated at 615. If the CPU has not overheated at 615, the portable computer may be powered at 617 using the battery until the LV of SOC has been reached. If the CPU has overheated at 615, the portable computer may be placed in normal power mode at 619. If the SOC is not greater than LV at 613, the portable computer may be placed in normal charge mode until LV of SOC has been reached at 621. The algorithm may then approximate if the CPU has overheated 623. If the CPU has not overheated at 623, the portable computer may be placed in normal power mode at 625. If the CPU has overheated at 623, the algorithm may decide to charge the battery to HV at 627, and the algorithm may repeat the approximation of whether the SOC is greater than LV at 613.

The portable computer may also include a plurality of cells contained within a battery cell pack housing and coupled to the at least one heat generating component.

The battery cell pack housing may be located under the palm rest of the portable computer.

In another embodiment, the invention includes battery pack 710, an exploded view of which is shown in FIG. 7. Battery pack 710 includes battery cell arrangement 712 of battery cells 714, electrically connected to circuit 716 by metal strip 718. Case 720a,b of battery pack 710 defines compartment 722 that is in fluid communication with metal strip 718. Heat pipe 724 is located within compartment 722 and is in direct contact with battery casing 726 of at least one battery cell 714 of battery cell arrangement 712. The battery casing 726 encloses the battery cell arrangement 712 and functions as a shield that protects the battery cell 714 from direct heat radiation. Alternatively, heat pipe 724 is in direct contact with metal strip 718. Heat pipe 724 is connected to a heat pipe (not shown) extending to a source of heat within a notebook much as a CPU or GPU. It is to be noted that heat pipe 724 is otherwise electrically insulated from other circuitry of the notebook. Examples of suitable materials of heat pipe 724 include those having a thermal conductivity of at least 7 BTU/(hr ° F. ft²/ft). Such examples of preferred materials of heat pipe 724 include aluminum, copper and their alloys, such as alloys of aluminum and copper.

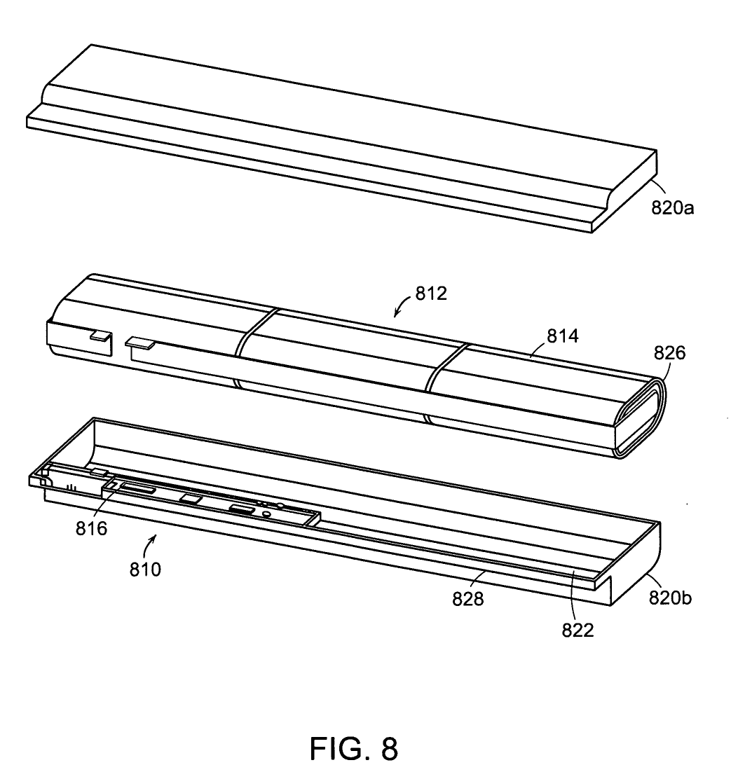

In still another embodiment of a battery pack 810, shown in FIG. 8, the battery pack 810 includes a case 820a, 820b, a battery casing 826 with a battery cell arrangement 812 comprised of batteries 814, a circuit 816, and a compartment 822. The battery casing 820b defines slot 828 for insertion of a heat pipe (not shown) from the notebook and contact of that heat pipe with another heat pipe, e.g., heat pipe 724 as shown in FIG. 7, of battery pack 710. Otherwise, the battery pack 810 functions in a similar manner as battery pack 710 of FIG. 7.

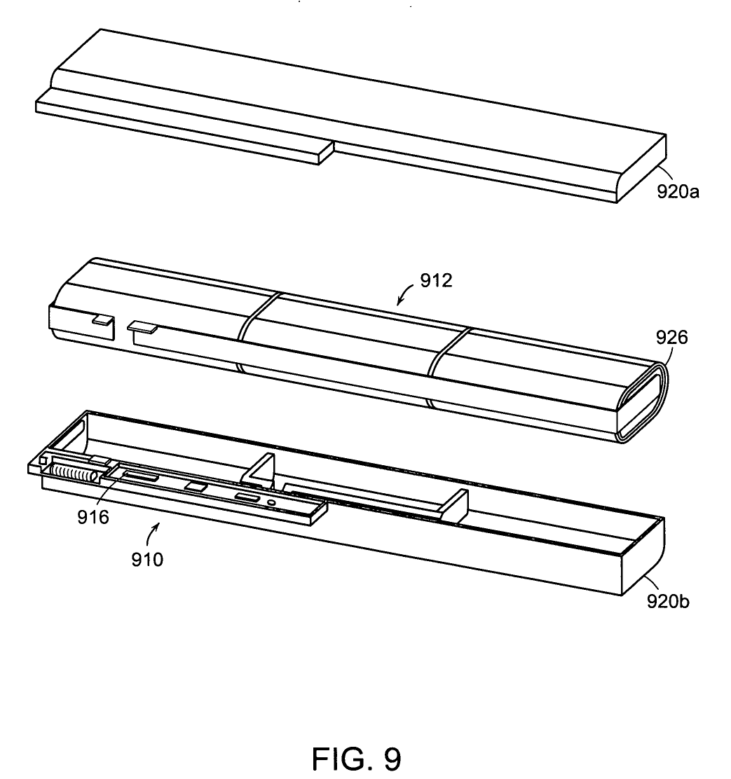

Another embodiment of a battery pack 910, shown in FIG. 9, includes a case 920a, 920b, a battery cell arrangement 912, and a circuit 916. The battery casing 926 includes a material, at least in part, that provides points of contact between a casing of at least one battery cell 914 of battery cell arrangement 912 and a heat pipe or chassis of the notebook. Examples of suitable materials of battery casing 926 include thermally conductive plastics, such as those well-known in the art, including those that incorporate various fillers, including but not limited to ceramics and carbon fibers, in a resin, including but not limited to polymer, polyamide, poly propylene, polyphenylene sulfide and thermoplastic elastomer. Such materials typically have thermal conductivities greater than about 1 W/mk and up to about 100 W/mk or beyond. Specific examples of suitable polymers include CoolPoly® thermally conductive plastic from Cool Polymers, Inc. of Warwick, R.I.; RTP 199 X 91020 A Z® Thermally Conductive Polypropylene from RTP Company of Winona, Minn.; and Mack TCP® (Thermally Conductive Plastic) from Mack Plastics Corporation of Bristol, R.I.

While this invention has been particularly shown and described with references to example embodiments thereof, it will be understood by those skilled in the art that various changes in form and details may be made therein without departing from the scope of the invention encompassed by the appended claims.

Even though embodiments have been shown and described that involve CPUs and GPUs, it should be understood by one with ordinary skill in the art that additional embodiments are available.

It should also be understood that the flow diagram of FIG. 6 is an example that may include more or fewer components, be partitioned into subunits, or be implemented in different combinations.

What is claimed is:

1. A portable computer comprising:
a) at least one heat generating component; and
b) a battery cell thermally coupled to the at least one heat generating component.

2. The portable computer as claimed in claim 1, wherein at least one radiating wall of the battery cell has an enhanced surface area.

3. The portable computer as claimed in claim 2, wherein the radiating wall includes fins.

4. The portable computer as claimed in claim 2, wherein the radiating wall includes pins.

5. The portable computer as claimed in claim 2, wherein the radiating wall includes extruded features.

6. The portable computer as claimed in claim 1, wherein the battery cell is coupled to a cooling assembly.

7. The portable computer as claimed in claim 6, wherein the cooling assembly includes a fan configured to direct airflow across the radiating wall of the battery cell.

8. The portable computer as claimed in claim 1, wherein the battery cell is enclosed in a shield configured to protect the battery cell from direct heat radiation.

9. The portable computer as claimed in claim 1, further comprising a motherboard of the portable computer.

10. The portable computer as claimed in claim 9, wherein the battery cell is coupled to the motherboard of the portable computer.

11. The portable computer as claimed in claim 9, wherein the battery cell is coupled using at least one clip.

12. The portable computer as claimed in claim 9, wherein the battery cell is configured for detachment.

13. The portable computer as claimed in claim 9, wherein the battery cell is embedded within the motherboard of the computer.

14. The portable computer as claimed in claim 1, wherein the battery cell is located on top of, within, or spanning the motherboard of the portable computer.

15. The portable computer as claimed in claim 1, wherein the heat generating component is a processor.

16. The portable computer as claimed in claim 15, wherein the processor is a central processing unit chip.

17. The portable computer as claimed in claim 16, wherein the central processing unit chip is thermally bonded to the battery cell.

18. The portable computer as claimed in claim 15, wherein the processor is a graphics processing unit chip.

19. The portable computer as claimed in claim 18, wherein the graphics processing unit chip is thermally bonded to the battery cell.

20. The portable computer as claimed in claim 1, wherein the battery cell is a prismatic aluminum cell.

21. The portable computer as claimed in claim 1, wherein the battery cell is a positive electrode.

22. The portable computer as claimed in claim 1, wherein the battery cell is oriented under the palm rest of the portable computer.

23. The portable computer as claimed in claim 1, including a plurality of cells contained within a battery cell pack housing and coupled to the at least one heat generating component.

24. The portable computer as claimed in claim 23, wherein the battery cell pack housing is located under the palm rest of the portable computer.

25. The portable computer as claimed in claim 1, wherein heat capacity of the battery cell is greater than the heat capacity of the heat generating component.

26. The portable computer as claimed in claim 25, wherein the heat capacity of the battery cell is at least an order of magnitude greater than the heat capacity of the heat generating component.

27. The portable computer as claimed in claim 1, further comprising charge management control that preferentially charges the battery cell during times when cooling is required.

28. The portable computer as claimed in claim 1, further comprising a hard disk.

29. The portable computer as claimed in claim 28, wherein the hard disk is enclosed in a shield and the shield is configured to protect the hard disk from direct heat radiation.

30. The portable computer as claimed in claim 1, further comprising a optical drive.

31. The portable computer as claimed in claim 30, wherein the hard disk is enclosed in a shield and the shield is configured to protect the hard disk from direct heat radiation.

32. The portable computer as claimed in claim 1, including a plurality of cells distributed within a portable computer housing and individually, thermally coupled to the at least one heat generating component.

33. The portable computer as claimed in claim 32, wherein the plurality of cells is individually enclosed in a shield configured to protect the plurality of cells from direct heat radiation.

34. The portable computer as claimed in claim 1, where the plurality of cells is coupled to a motherboard of the portable computer.

35. The portable computer as claimed in claim 34, wherein the plurality of cells is coupled using at least one clip.

36. The portable computer as claimed in claim 34, wherein the plurality of cells is configured for detachment.

37. The portable computer as claimed in claim 32, wherein the plurality of cells is comprised of prismatic aluminum cells.

38. The portable computer as claimed in claim 32, wherein the plurality of cells is located under the palm rest of the portable computer.

39. The portable computer as claimed in claim 1, further comprising a thermal attachment block is thermally coupled between the at least one heat generating component and the battery cell.

40. The portable computer as claimed in claim 1, further comprising a heat pipe thermally coupled between the at least one heat generating component and the battery cell.

41. A method for using a battery cell to assist in heat transfer within a portable computer comprising thermally coupling at least one heat generating component of the portable computer to the at least one heat generating component.

42. The method as claimed in claim 41, further comprising coupling the battery cell to a cooling assembly.

43. The method as claimed in claim 42, further comprising configuring the cooling assembly to direct airflow across at least one radiating wall of the battery cell, wherein the at least one radiating wall of the battery cell has an enhanced surface area.

44. The method as claimed in claim 41, further comprising enclosing the battery cell in a shield configured to protect the battery cell from direct heat radiation.

45. The method as claimed in claim 41, further comprising coupling the battery cell to a motherboard of the portable computer.

46. The method as claimed in claim 45, wherein coupling the battery cell includes using at least one clip.

47. The method as claimed in claim 45, further comprising configuring the battery cell for detachment.

48. The method as claimed in claim 41, further comprising charging the battery cells, preferentially, during times when cooling is required.

49. The method as claimed in claim 41, further comprising including the battery cell in a plurality of cells distributed within a portable computer housing and individually thermally coupled to the at least one heat generating component.

50. The method as claimed in claim 49, further comprising maintaining the temperature difference between each cell at least less than 10° C.

51. The method as claimed in claim 50, wherein the temperature difference between each cell is at least less than 2° C.

52. The method as claimed in claim 49, further comprising maintaining the capacity difference between each cell at least less than 60 mAH.

53. The method as claimed in claim 49, further comprising individually enclosing the plurality of cells in a shield configured to protect a respective cell from direct heat radiation.

54. The method as claimed in claim 49, further comprising coupling the plurality of cells to a motherboard of the portable computer.

55. The method as claimed in claim 49, further comprising configuring the plurality of cells for detachment.

56. The method as claimed in claim 41, further comprising regulating processing speeds of the portable computer based on temperature of the at least one heat generating component.

57. A device comprising:
at least one heat generating component; and
a battery cell thermally coupled to the at least one heat generating component.

58. The device of claim 57, wherein the device is portable.

59. The device of claim 57, wherein the battery cell is rechargeable.

60. The device of claim 59, wherein the battery cell includes lithium in a cathode of the battery cell.
